(19) United States
(12) Patent Application Publication
(10) Pub. No.: US 2014/0160161 A1
(43) Pub. Date: Jun. 12, 2014

(54) AUGMENTED REALITY APPLICATION

(71) Applicants: Patricio Barreiro, Buenos Aires (AR); Leonardo Di Paola, Buenos Aires (AR); Matias Carrasco, Garland, TX (US); Josue Gabriel Montemayor, Dallas, TX (US)

(72) Inventors: Patricio Barreiro, Buenos Aires (AR); Leonardo Di Paola, Buenos Aires (AR); Matias Carrasco, Garland, TX (US); Josue Gabriel Montemayor, Dallas, TX (US)

(21) Appl. No.: 14/099,866

(22) Filed: Dec. 6, 2013

Related U.S. Application Data
(60) Provisional application No. 61/733,968, filed on Dec. 6, 2012.

(51) Int. Cl. G06T 11/60; G06K 9/00

(52) U.S. Cl. CPC G06T 11/60; G06K 9/00671
USPC 345/633

(57) ABSTRACT

An apparatus and computerized method include providing a memory, a display, an image source, and a processor communicably coupled to the memory, the display and the image source. The processor receives an image from the image source, detects at least one target within the image, retrieves an electronic content associated with the target, creates an augmented image by combining the image with the electronic content associated with the target and displays the augmented image on the display.

### CROSS-REFERENCE TO RELATED APPLICATIONS

This application claims priority to and is a non-provisional patent application of U.S. Provisional Patent Application Ser. No. 61/733,968, filed on Dec. 6, 2012, and entitled “Augmented Reality Application”. The foregoing application is hereby incorporated by reference in its entirety.

### FIELD OF THE INVENTION

The present invention relates generally to the field of software applications and, more particularly, to an augmented reality application.

### BACKGROUND OF THE INVENTION

“Augmented reality (AR) is one type of reality-based interface. AR interfaces supplement the real world with virtual (computer generated) objects that appear to coexist in the same space as the real world.” (Source: R. Azuma, Y. Baillot, R. Behringer, S. Feiner, S. Julier, and B. MacIntyre, “Recent advances in augmented reality,” IEEE Computer Graphics and Applications, vol. 21, 2001, pp. 34-47. En: http://www.argamedesign.com).

### SUMMARY OF THE INVENTION

The present invention provides an apparatus that includes a memory, a display, an image source, and a processor communicably coupled to the memory, the display and the image source. The processor receives an image from the image source, detects at least one target within the image, retrieves an electronic content associated with the target, creates an augmented image by combining the image with the electronic content associated with the target and displays the augmented image on the display.

In addition, the present invention provides a computerized method of augmenting an image displayed to a user. A processor, a memory communicably coupled to the processor, a display communicably coupled to the processor and an image source communicably coupled to the processor are provided. An image is received from the image source. At least one target is detected within the image using the processor. An electronic content associated with the target is retrieved using the processor. An augmented image is created by combining the image with the electronic content associated with the target using the processor. The augmented image is displayed on the display.

These and other objects, advantages and features of this invention will be apparent from the following description taken with reference to the accompanying drawing, wherein is shown a preferred embodiment of the invention.

### BRIEF DESCRIPTION OF THE DRAWINGS

The above and further advantages of the invention may be better understood by referring to the following description in conjunction with the accompanying drawings, in which:

FIG. 1 is a block diagram of an apparatus in accordance with one embodiment of the present invention;

FIG. 2 is a flow chart of a computerized method of augmenting an image displayed to a user in accordance with one embodiment of the present invention;

FIG. 3 is a flow chart of a computerized method of augmenting an image displayed to a user in accordance with one embodiment of the present invention;

FIGS. 4-9 are various examples of the augmented reality in accordance with the present invention; and

FIGS. 10-13 are examples of various augmented reality applications in accordance with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

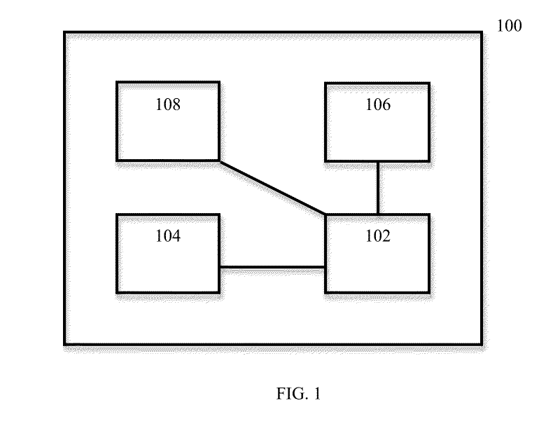

FIG. 1 is a block diagram of an apparatus 100 in accordance with one embodiment of the present invention. The apparatus 100 includes a memory 104, a display 106, an image source 108, and a processor 102 communicably coupled to the memory 104, the display 106 and the image source 108. The processor 102 receives an image from the image source 108, detects at least one target within the image, retrieves an electronic content associated with the target, creates an augmented image by combining the image with the electronic content associated with the target and displays the augmented image on the display 106. The image source 108 may include a camera, a data storage device, an electronic content delivery device or a webpage. The image may include a graphic image, a photograph or a video stream. The content may include a video, an animation, a three-dimensional model, a new image, a text, a link to additional information or electronic content. The apparatus can be a mobile phone, an electronic tablet, a computer, a gaming device, a wrist worn electronic device, a handheld electronic device or any other suitable device. The steps preformed by the processor will be further described below.

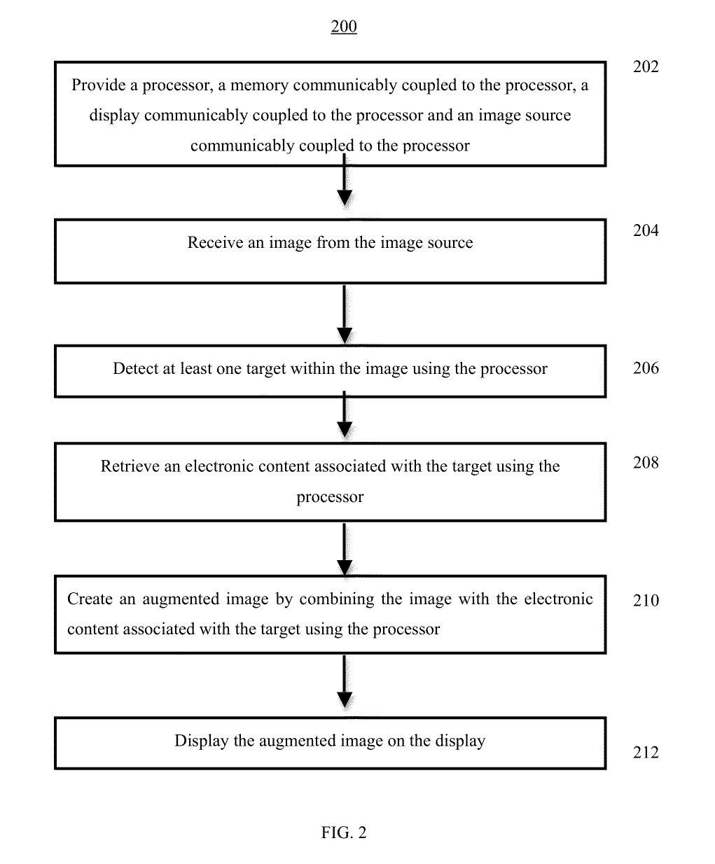

FIG. 2 is a flow chart of a computerized method 200 of augmenting an image displayed to a user in accordance with one embodiment of the present invention. A processor, a memory communicably coupled to the processor, a display communicably coupled to the processor and an image source communicably coupled to the processor are provided in block 202. An image is received from the image source in block 204. At least one target is detected within the image using the processor in block 206. An electronic content associated with the target is retrieved using the processor in block 208. An augmented image is created by combining the image with the electronic content associated with the target using the processor in block 210. The augmented image is displayed on the display in block 212.

The method may also include the steps of tracking the target within the video stream and adjusting the augmented image. Similarly, the method may include the step of adjusting the electronic content within the augmented image based on a change in the target within the image using the processor. Likewise, the method may include the step of continuously repeating the receiving, detecting, retrieving, creating and displaying steps as long as the image is received from the image source. Other steps may include: (1) receiving one or more user commands and changing the augmented image based on the one or more user commands using the processor; (2) detecting one or more interest points, fiduciary markers or optical flow associated with the target within the image using a feature detection method and the processor, and identifying the target using the one or more interest points, fiduciary markers or optical flow and the processor; and/or (3) retrieving the electronic content from a remote source via a network. The feature detection method can be a corner detection method, a blob detection method, an edge detection or thresholding method, or a combination thereof. The steps can be performed in real time or near real time.

As described above, the image source may include a camera, a data storage device, an electronic content delivery device or a webpage. The image may include a graphic image, a photograph or a video stream. The content may include a video, an animation, a three-dimensional model, a new image, a text, a link to additional information or electronic content. The apparatus can be a mobile phone, an electronic tablet, a computer, a gaming device, a wrist worn electronic device, a handheld electronic device or any other suitable device. The steps preformed by the processor will be further described below.

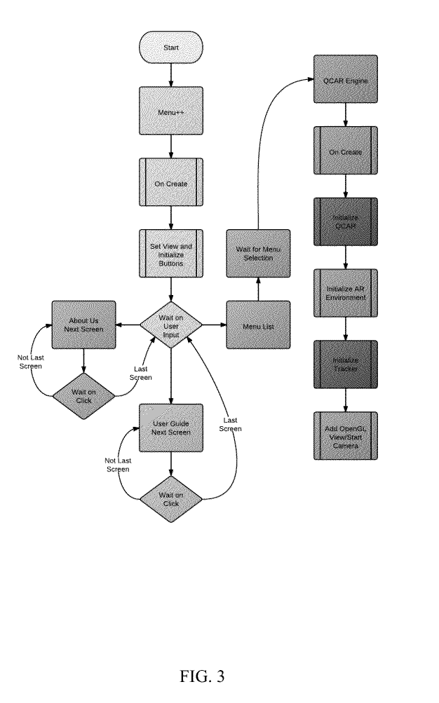

FIG. 3 is a flow chart of a method in accordance with one embodiment of the present invention.

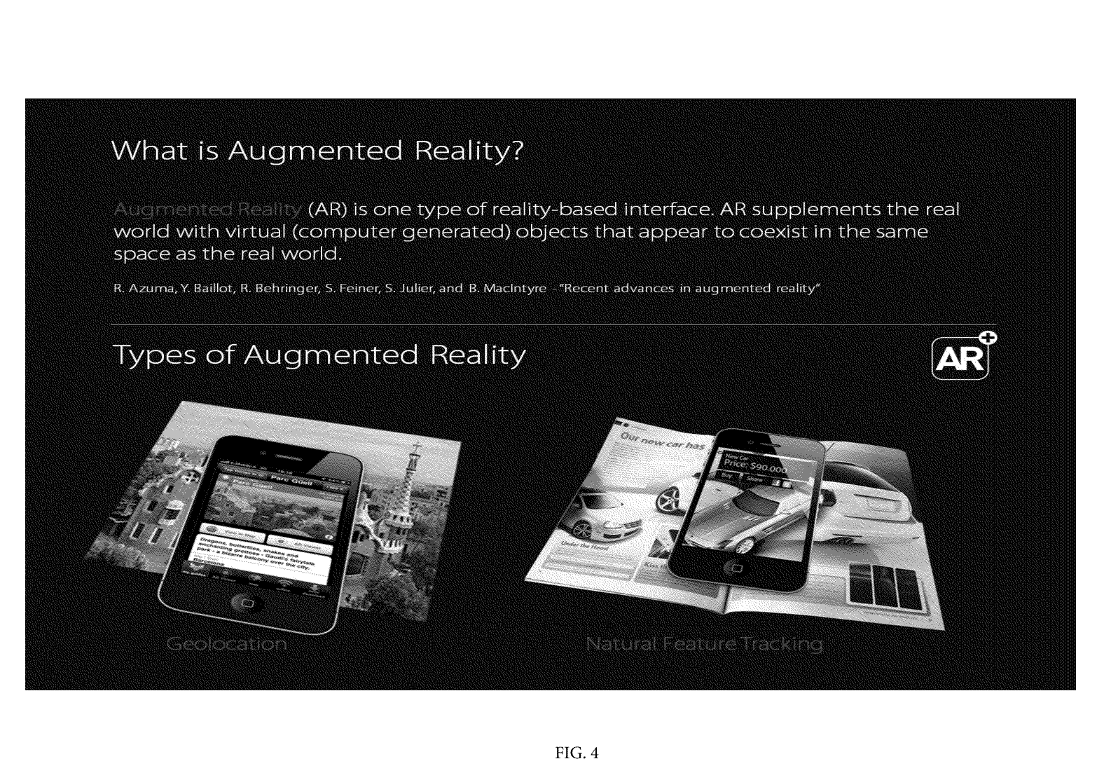

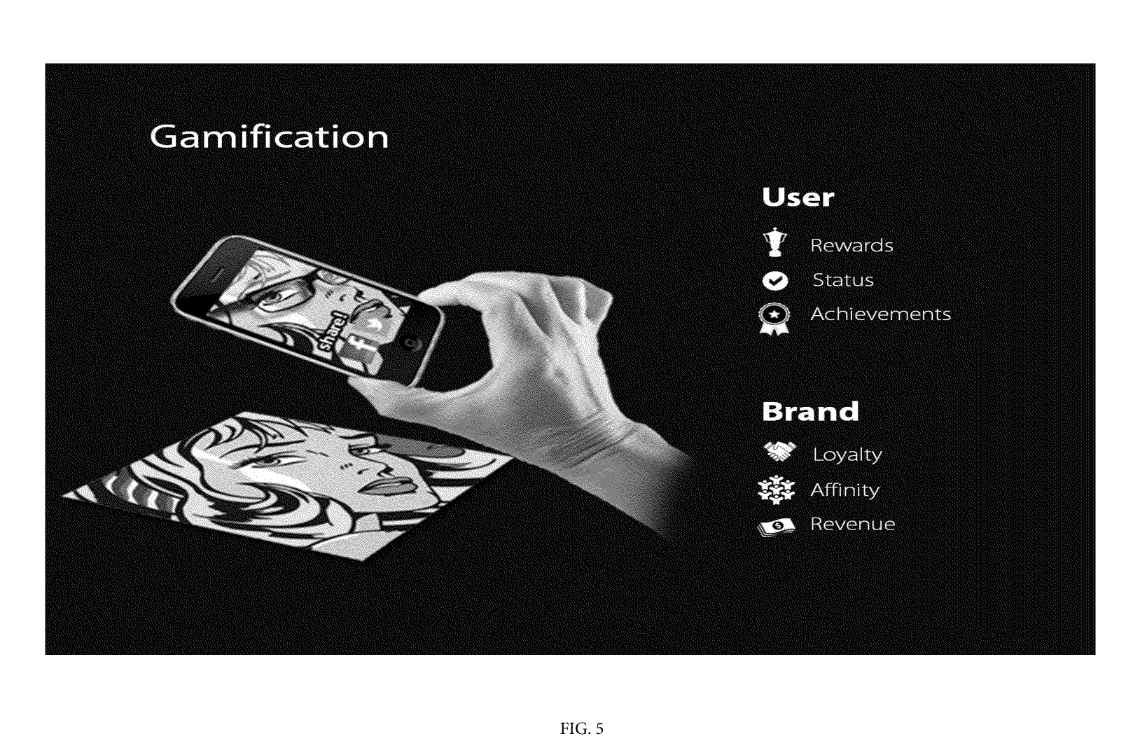

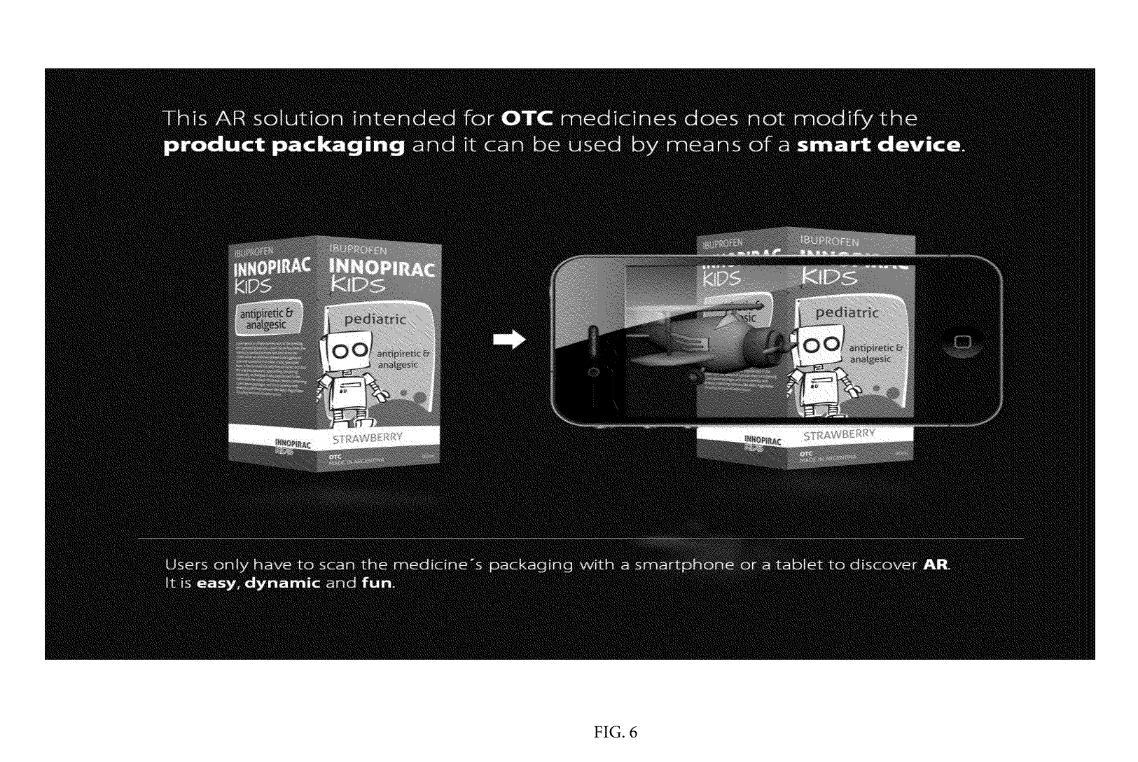

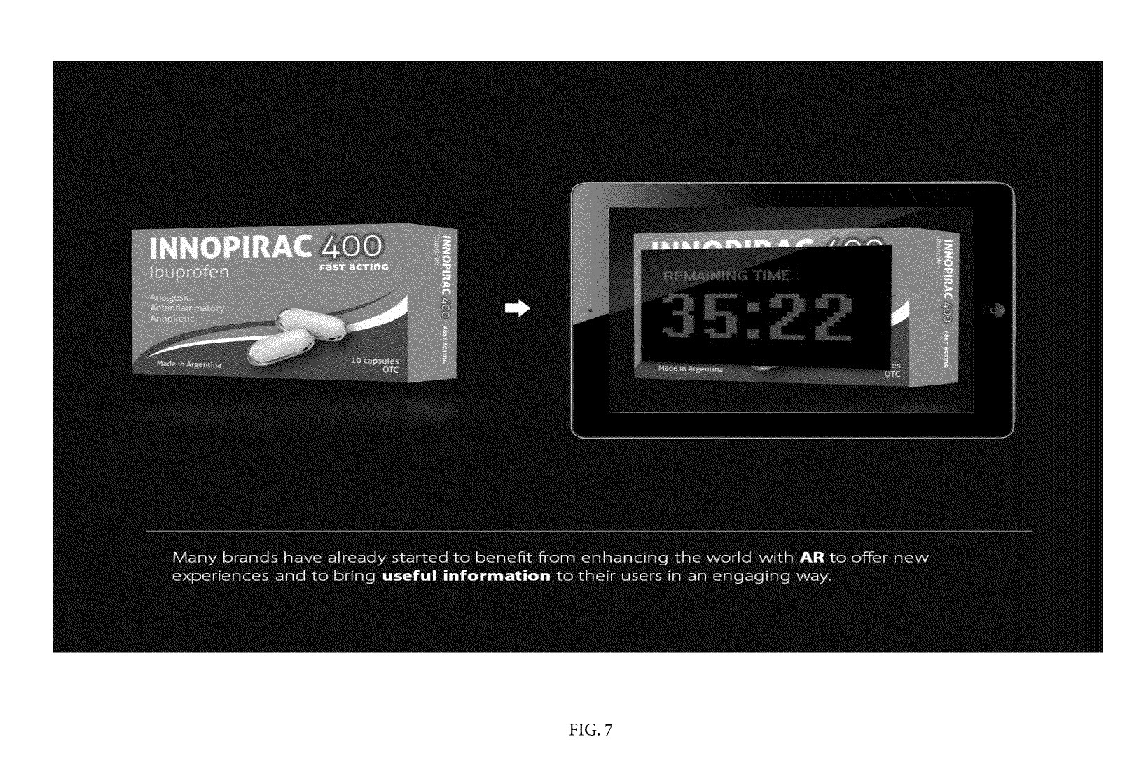

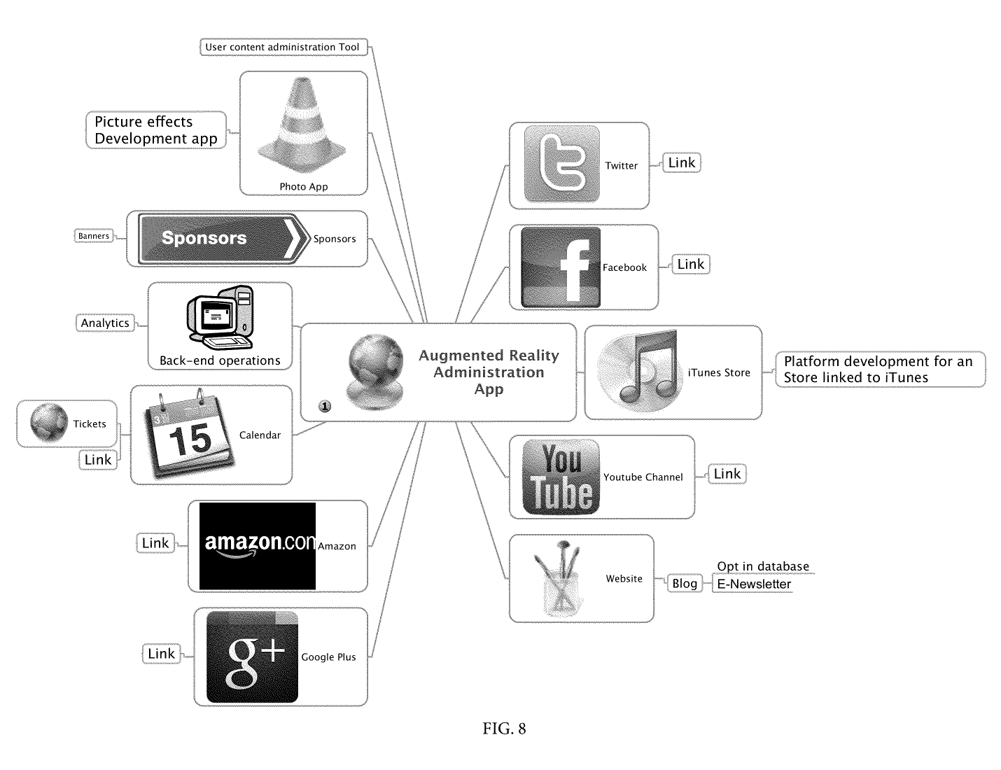

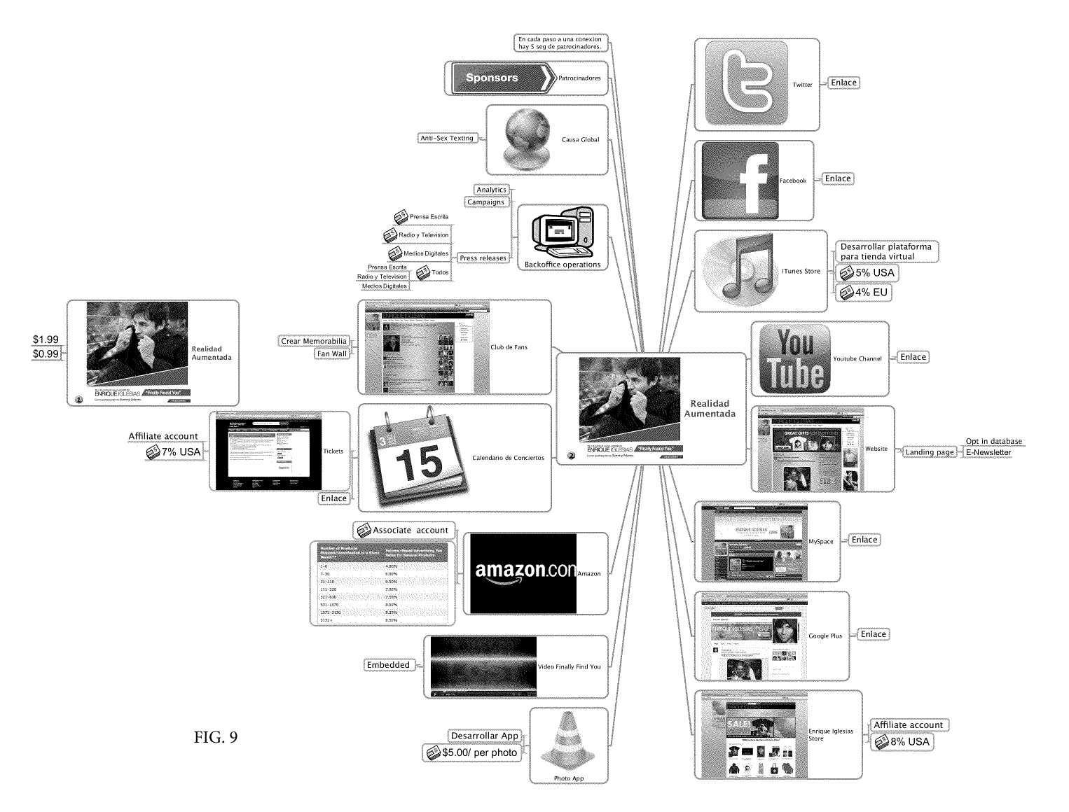

FIGS. 4-9 provide any overview of augmented reality, a diagram of an augmented reality application in accordance with the present invention, and an example of the augmented reality application in use with respect to an image captured by a smart phone or device of Enrique Iglesias. More specifically, the present invention provides the links and functionality in response to detecting an object displayed in the camera mode of the smart phone or device. An actual picture does not have to be taken. The application works directly off of images captured by the camera in real time.

Augmented reality (AR) is a brand new technology that combines physical and virtual elements in order to create a mixed reality which is projected on a smart device screen. In this way, virtual information is added to the one that already exists, but instead of replacing it, as virtual reality does, augmented reality overprints contents to the physical environment. AR applications reinvent the way to know places and products as they allow to interact with a wide variety of elements and they enrich different practices, from shopping to reading a magazine, a book or a newspaper.

This technology enhances brand experiences in an integral way improving products and services positioning because it calls on consumers in a dynamic and much more entertaining way than traditional advertising. This technology can be used over cards, maps, tables, walls, objects and websites (Natural Feature Trackers) or by pointing towards a geographic coordinate (Points of Interest). AR may be used whenever desired on existing products without any need to modify their image or packaging.

Augmented Reality Business Models may include branding, gaming, education, shopping, tourism, recognition & targeting, and/or virtual Ads. Types: NFT (Natural Feature Tracking): with AR Markers, images and objects.

Geolocation (POIs)

QR Codes evolution→NFT

QR codes could be used when they generate actual value for users through new interactional initiatives that give user better rewards and experiences. Now, a new and even more engaging alternative has arrived, which might replace the QR codes and allow brands to interact with their users in unique ways: Blippar (replace it for “AR/differente AR platforms”).

AR app makes it possible to alter the world around you and bring rich interactive experiences to users through image recognition and image layering—bringing brands to life. There is no scanning needed, so rather than a simple QR code, the app recognizes all kinds of images such as product labels, magazines, billboards or even a physical building.

AR may be used on existing products without any need to modify their image or packaging. (Source: http://www.mindjumpers.com)

Gamification

Is the concept of applying game-design thinking to non-game applications to make them more fun and engaging? It has quickly become one of the most talked about trends in Silicon Valley, with google trends showing the explosive growth continuing to accelerate. Can potentially be applied to any industry and almost anything to create fun and engaging experiences, converting users into players. Gamification has started being popularized as the next big thing in marketing. A Fortune article stated “Companies are realizing that “gamification”—using the same mechanics that hook gamers—is an effective way to generate business. More recently, the technique captured the attention of venture capitalists, one of whom said he considered gamification to be the most promising area in gaming. Another observed that half of all companies seeking funding for consumer software applications mentioned game design in their presentations. (Source: http://gamification.org)

Putting game mechanics into traditionally non-game user applications, such as software and online services, is gaining speed as a business strategy that not only increases user participation, but also results and revenue, say advocates and industry players. Gamification can increase user participation because “the core emotion is empathy” (Dru Wynings, founder of Reputely). When a business applies a game element to its product or service, this provides an instant feedback loop and a clear sense of progress, all of which are “inherently engaging” (Dru Wynings, founder of Reputely).

Almost all businesses can benefit from gamifying their user's experience because “fundamentally, consumers respond well to fun and reward systems”. (Gabriel Zichermann, author of the Gamification Blog). Various sectors, from banking to education and healthcare, can apply a social game mechanism to their services because the goal is to create loyalty, engagement and participation while driving business value, which typically means direct or indirect revenue and better ROI.

When brands can interact in more meaningful ways with their customers, they satisfy the users' fundamental need for reward, status and achievement within the context of a brand. This drives loyalty, brand affinity and revenue.

Furthermore, integration of games mechanics into the site encourages more pageviews as well as ad impressions, which will generate revenue. For instance, gamification apps on e-commerce sites could drive conversion rates and average order sizes. (Source: http://www.zdnet.com)

Games in health are often used to educate patients or promote healthy lifestyles. Now games are being used to educate physicians and medical office staff as well. As more practices adopt electronic health records, patient privacy and data security have become bigger challenges. (Source: http://www.gamification.co)

Magnify Kids—Packaging

This project is intended for OTC medicines

Benefits of an AR Apps and specially for OTC medicines

This solution does not modify the product and it can be used by means of a smartphone or a tablet. Users only have to scan the medicine's packaging with a mobile device to discover AR.

It is easy, dynamic and fun. The main aim of this app is to increase kids acceptance to medicines, making the traumatic moment of taking the medicine a much funnier one. E.g. Band Aid.

Augmented Reality Muppets Band-Aids Distract Your Kids From Pain

The new Band-Aids work with a free “Magic Vision” AR app for iOS. When your wee one snaps a photo of the Muppets Band-Aid covering their ouchie, the app presents them with fun interactive animations that'll help turn their pain into smiles. A new generation of Muppets fans and your kids aren't crying anymore. (BAND-AID®) VIDEO LK: http://www.youtube.com/watch?feature=player_embedded&v=lm5-KPW0x3U

It will be available for iOS and Android devices.

Augmented Reality can leverage the brand experience in an integral way.

AR offers many digital reactions to create engagement, and many of them include social sharing experiences.

The digital experiences may be in the shape of “a mobile augmented reality overlay (offering further content or an interactive on-phone screen experience), a web link or m-commerce link, location-based direction to the nearest ‘x’, a digital hijack or graffiti, gaming and ‘hidden clues’ or couponing and direct-response sales promotions”—the only limit is the imagination of the creative team.

Many brands have already started to benefit from enhancing the world with augmented reality to offer new experiences and to bring useful information to their users in engaging and exciting ways. (Source: http://www.mindjumpers.com)

Different Industries

View Augmented Reality Business Models above.

The present invention uses Incremental Iterative and Scrum methodologies to build the applications. The development consists of Requirement with the Client, Analysis and Design, Implementation, Deployment and testing.

Augmented Reality consists on merging the real world with a virtual environment with the use of special software, to enrich a new visual experience and enhance a better communication channel. With this technology we can add new information with the existing reality. For example we can see the content of a closed box only pointing to the box with our camera.

AR systems are how realistically they integrate augmentations with the real world. The software must derive real world coordinates, independent from the camera, from camera images. That process is called image registration which uses different methods of computer vision, mostly related to video tracking Usually those methods consist of two parts.

First detect interest points, or fiduciary markers, or optical flow in the camera images over the image target. First stage can use feature detection methods like corner detection, blob detection, edge detection or thresholding and/or other image processing methods.

Second, once the match with the marker and the real object is reached, it executes a process to activate the new content. Such as play a video, show 3d models or Images, or other events through internet.

Augmented Reality mobile technologies (AR) represents the ability to enrich the way we interact with the world. The technology alternates between software enhanced multimedia elements pre-programmed on Smartphones and Tablets while interacting over the view of concrete objects.

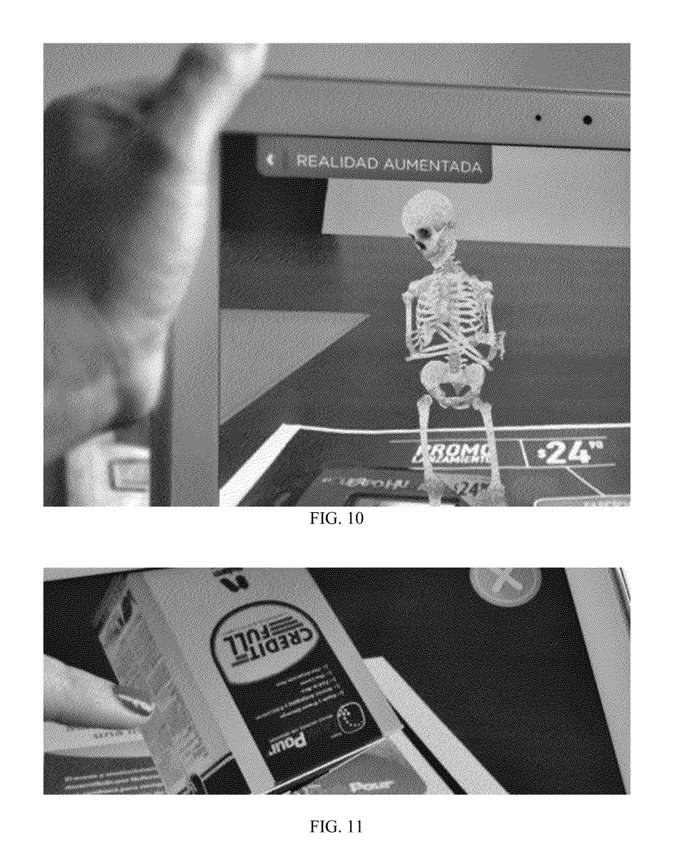

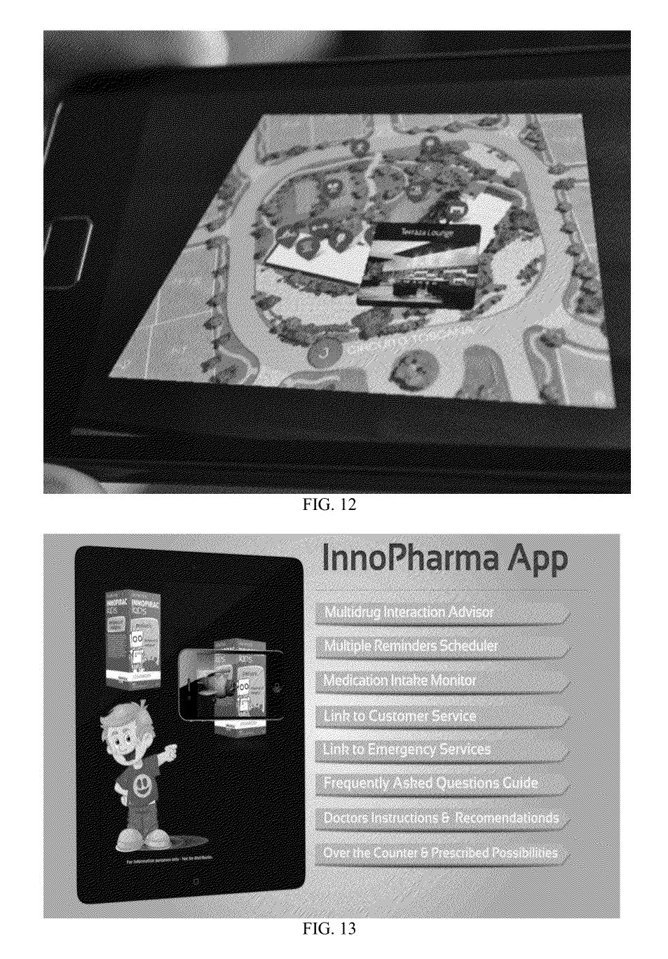

FIGS. 10-13 show image of augmented reality applications for the human body, agrochemicals, hotels and pharmaceuticals in accordance with one embodiment of the present invention.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A computerized method of augmenting an image displayed to a user comprising the steps of:
providing a processor, a memory communicably coupled to the processor, a display communicably coupled to the processor and an image source communicably coupled to the processor;
receiving an image from the image source;
detecting at least one target within the image using the processor;
retrieving an electronic content associated with the target using the processor;
creating an augmented image by combining the image with the electronic content associated with the target using the processor; and
displaying the augmented image on the display.

2. The method as recited in claim 1, the image comprising a video stream and further comprising the steps of:
tracking the target within the video stream; and
adjusting the augmented image.

3. The method as recited in claim 1, further comprising the step of continuously repeating the receiving, detecting, retrieving, creating and displaying steps as long as the image is received from the image source.

4. The method as recited in claim 1, further comprising the step of adjusting the electronic content within the augmented image based on a change in the target within the image using the processor.

5. The method as recited in claim 1, further comprising the steps of:
receiving one or more user commands; and
changing the augmented image based on the one or more user commands using the processor.

6. The method as recited in claim 1, the detecting step further comprising the steps of:
detecting one or more interest points, fiduciary markers or optical flow associated with the target within the image using a feature detection method and the processor; and
identifying the target using the one or more interest points, fiduciary markers or optical flow and the processor.

7. The method as recited in claim 6, the feature detection method comprising a corner detection method, a blob detection method, an edge detection or thresholding method, or a combination thereof

8. The method as recited in claim 1, further comprising the step of retrieving the electronic content from a remote source via a network.

9. The method as recited in claim 1, where in the steps are performed in real time or near real time.

10. The method as recited in claim 1, the image source comprising a camera, a data storage device, an electronic content delivery device or a webpage.

11. The method as recited in claim 1, the image comprising a graphic image, a photograph or a video stream.

12. The method as recited in claim 1, the content comprising a video, an animation, a three-dimensional model, a new image, a text, a link to additional information or electronic content.

13. The method as recited in claim 1, the processor, the memory and the display comprising a mobile phone, an electronic tablet, a computer, a gaming device, a wrist worn electronic device or a handheld electronic device.

14. An apparatus comprising:
a memory;
a display;
an image source; and
a processor communicably coupled to the memory, the display and the image source, the processor receiving an image from the image source, detecting at least one target within the image, retrieving an electronic content associated with the target, creating an augmented image by combining the image with the electronic content associated with the target and displaying the augmented image on the display.

15. The apparatus as recited in claim 14, the image source comprising a camera, a data storage device, an electronic content delivery device or a webpage.

16. The apparatus as recited in claim 14, the image comprising a graphic image, a photograph or a video stream.

17. The apparatus as recited in claim 14, the content comprising a video, an animation, a three-dimensional model, a new image, a text, a link to additional information or electronic content.

18. The apparatus as recited in claim 14, the apparatus comprising a mobile phone, an electronic tablet, a computer, a gaming device, a wrist worn electronic device or a handheld electronic device.

19. The apparatus as recited in claim 14, the image comprising a video stream and the processor further tracking the target within the video stream and adjusting the augmented image.

20. The apparatus as recited in claim 14, the processor further:
detecting one or more interest points, fiduciary markers or optical flow associated with the target within the image using a feature detection method ; and
identifying the target using the one or more interest points, fiduciary markers or optical flow.
